(19) United States
(12) Patent Application Publication
(10) Pub. No.: US 2016/0127787 A1
(43) Pub. Date: May 5, 2016

(54) METHOD AND SYSTEM FOR RECOMMENDING MEDIA TO A USER

(71) Applicant: THOMSON LICENSING, Issy Les Moulineaux (FR)

(72) Inventor: Jagjeet Singh KHALSA, San Diego, CA (US)

(21) Appl. No.: 14/896,463

(22) PCT Filed: Aug. 2, 2013
(86) PCT No.: PCT/US13/53438

§ 371 Date: Dec. 7, 2015

Related U.S. Application Data
(60) Provisional application No. 61/833,039, filed on Jun. 10, 2013.

(51) Int. Cl. H04N 21/475; H04N 21/466; H04N 21/25; H04N 21/442; H04N 21/45

(52) U.S. Cl. CPC H04N 21/4756; H04N 21/44222; H04N 21/4532; H04N 21/251; H04N 21/4667; H04N 21/4668

(57) ABSTRACT

A method and system are provided for recommending media to a user. The method includes providing on a display screen a plurality of rating options for a user to select from among. Each of the plurality of rating options corresponds to a respective grouping between at least two related media items to be rated by the user. The method further includes receiving a rating for the respective grouping between the at least two related media items corresponding to a user selected one of the plurality of rating options. The method also includes generating media recommendations for the user responsive to the rating. The method additionally includes providing the media recommendations to the user on the display screen.

### CROSS-REFERENCE TO RELATED APPLICATIONS

This application claims the benefit of U.S. Provisional Application Ser. No. 61/833,039 (Attorney Docket No. PU130080), filed Jun. 10, 2013, which is incorporated by reference herein in its entirety.

### TECHNICAL FIELD

The present principles relate generally to media and, more particularly, to a method and system for recommending media to a user.

### BACKGROUND

When a user typically rates programming, they typically are only rating the programming itself, not the actor's or director's work.

### SUMMARY

These and other drawbacks and disadvantages of the prior art are addressed by the present principles, which are directed to a method and system for recommending media to a user.

According to an aspect of the present principles, there is provided a method. The method includes providing on a display screen a plurality of rating options for a user to select from among. Each of the plurality of rating options corresponds to a respective grouping between at least two related media items to be rated by the user. The method further includes receiving a rating for the respective grouping between the at least two related media items corresponding to a user selected one of the plurality of rating options. The method also includes generating media recommendations for the user responsive to the rating. The method additionally includes providing the media recommendations to the user on the display screen.

According to another aspect of the present principles, there is provided a system. The system includes a ratings options manager for providing on a display screen a plurality of rating options for a user to select from among. Each of the plurality of rating options corresponds to a respective grouping between at least two related media items to be rated by the user. The ratings options manager is also for receiving a rating for the respective grouping between the at least two related media items corresponding to a user selected one of the plurality of rating options. The system further includes a media recommendation generator for generating media recommendations for the user responsive to the rating.

According to yet another aspect of the present principles, there is provided a non-transitory computer readable storage medium having computer executable code stored thereon for performing a method. The method includes providing on a display screen a plurality of rating options for a user to select from among. Each of the plurality of rating options corresponds to a respective grouping between at least two related media items to be rated by the user. The method further includes receiving a rating for the respective grouping between the at least two related media items corresponding to a user selected one of the plurality of rating options. The method also includes generating media recommendations for the user responsive to the rating. The method additionally includes providing the media recommendations to the user on the display screen.

These and other aspects, features and advantages of the present principles will become apparent from the following detailed description of exemplary embodiments, which is to be read in connection with the accompanying drawings.

### BRIEF DESCRIPTION OF THE DRAWINGS

The present principles may be better understood in accordance with the following exemplary figures, in which:

FIG. 1 shows an exemplary system 100 for delivering video content to which the present principles may be applied, in accordance with an embodiment of the present principles;

FIG. 2 shows an exemplary processing system 200 to which the present principles may be applied, according to an embodiment of the present principles, is shown;

FIG. 3 shows an exemplary system 300 for recommending media to a user, in accordance with an embodiment of the present principles;

FIG. 4 shows an exemplary method 400 for recommending media to a user, in accordance with an embodiment of the present principles; and

FIG. 5 shows further shows step 450 of method 400 of FIG. 4, in accordance with an embodiment of the present principles.

### DETAILED DESCRIPTION

The present principles are directed to a method and system for recommending media to a user. It is noted that in various media (including, but not limited to, movies, television programs, and so forth), many items form a particular relationship. As co-variance is known to refer to a measure of “linear dependence” between two items, in an embodiment the present principles take advantage of co-variance in generating media recommendations for a user based on ratings for media related groupings.

In an embodiment, the present principles provide a user with the ability to submit ratings for specific pairings (or groupings involving more than two members) of actors, movie genres, directors, and so forth. In an embodiment, the present principles allow for rating beyond just rating movies or actors by themselves, instead allowing for the rating of groupings such as, but not limited to, how actors work together, how an actor operates under the direction of a specific director, and so forth. The preceding grouping examples are merely illustrative and, thus, any type of grouping implicated by the underlying content can be rated and used in accordance with the teachings of the present principles. In an embodiment, the ratings can be used for generating programming suggestions.

The present description illustrates the present principles. It will thus be appreciated that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor(s) to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the present principles. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “NB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Initially, a system for delivering various types of content to a user will be described.

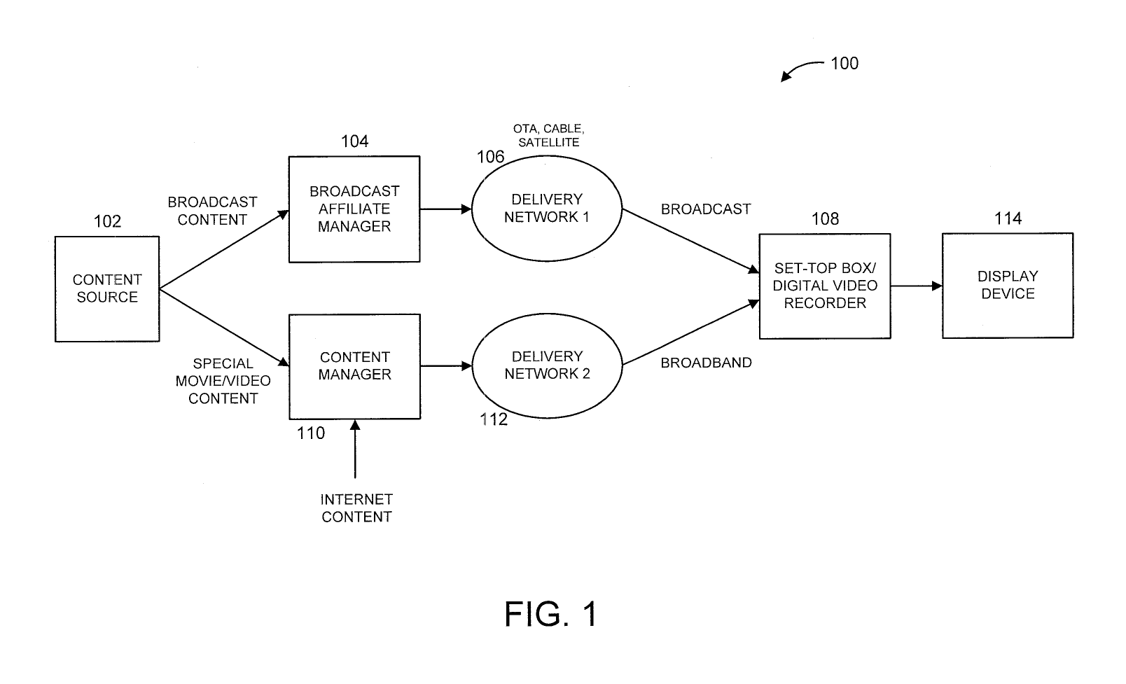

FIG. 1 shows an exemplary system 100 for delivering video content to which the present principles may be applied, in accordance with an embodiment of the present principles. The content originates from a content source 102, such as a movie studio or production house. The content may be supplied in at least one of two forms. One form may be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager may collect and store the content, and may schedule delivery of the content over a deliver network, shown as delivery network 1 (106). Delivery network 1 (106) may include satellite link transmission from a national center to one or more regional or local centers. Delivery network 1 (106) may also include local content delivery using local delivery systems such as over the air broadcast, satellite broadcast, or cable broadcast. The locally delivered content is provided to a user's set top box/digital video recorder (DVR) 108 in a user's home, where the content will form part of the results of subsequent searches by the user.

A second form of content is referred to as special content. Special content may include content that may have been delivered as premium viewing, pay-per-view, or other content otherwise not provided to the broadcast affiliate manager. In many cases, the special content may be content requested by the user. The special content may be delivered to a content manager 110. The content manager 110 may be a service provider, such as an Internet website, affiliated, for instance, with a content provider, broadcast service, or delivery network service. The content manager 110 may also incorporate Internet content into the delivery system, or explicitly into the search only such that content may be searched that has not yet been delivered to the user's set top box/digital video recorder 108. The content manager 110 may deliver the content to the user's set top box/digital video recorder 108 over a separate delivery network, delivery network 2 (112). Delivery network 2 (112) may include high-speed broadband Internet type communications systems. It is important to note that the content from the broadcast affiliate manager 104 may also be delivered using all or parts of delivery network 2 (112) and content from the content manager 110 may be delivered using all or parts of Delivery network 1 (106). In addition, the user may also obtain content directly from the Internet via delivery network 2 (112) without necessarily having the content managed by the content manager 110.

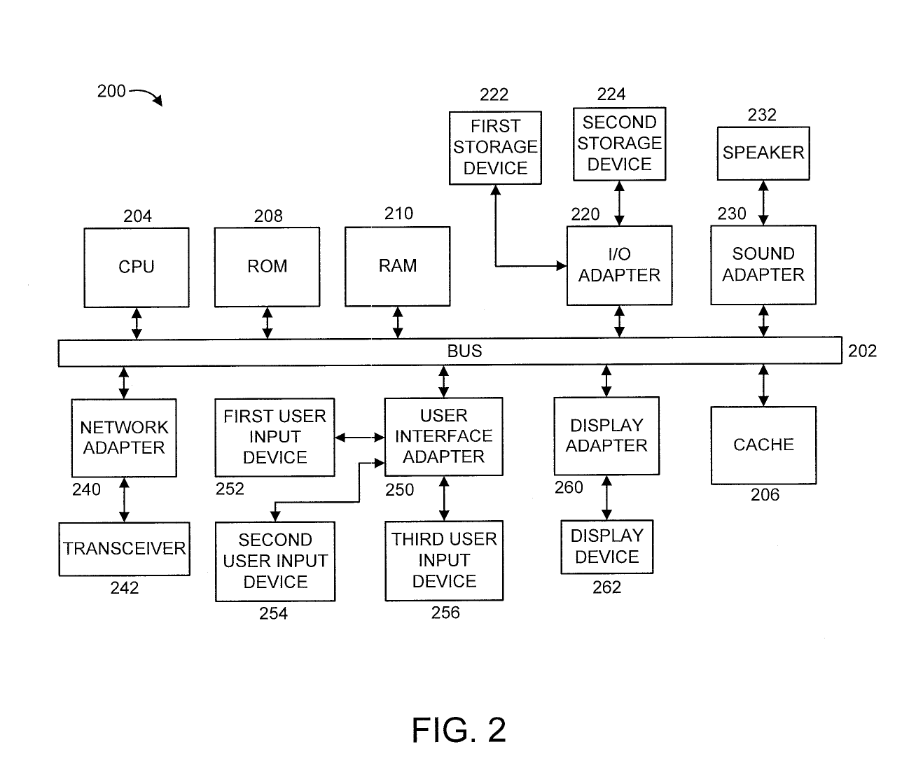

The set top box/digital video recorder 108 may receive different types of content from one or both of delivery network 1 and delivery network 2. The set top box/digital video recorder 108 processes the content, and provides a separation of the content based on user preferences and commands. The set top box/digital video recorder may also include a storage device, such as a hard drive or optical disk drive, for recording and playing back audio and video content. The processed content is provided to a display device 114. The display device 114 may be a conventional 2-D type display or may alternatively be an advanced 3-D display. It should be appreciated that other devices having display capabilities such as wireless phones, PDAs, computers, gaming platforms, remote controls, multi-media players, or the like, may employ the teachings of the present disclosure and are considered within the scope of the present disclosure. In some embodiments, at least display device 114, and in other embodiments, also set top box/digital video recorder 108, can be replaced by a processing system having a display such as processing system 200 shown and described with respect to FIG. 2. The processing system 200 can be representative of any media consumption/presentation device.

FIG. 2 shows an exemplary processing system 200 to which the present principles may be applied, according to an embodiment of the present principles, is shown. The processing system 200 includes at least one processor (CPU) 204 operatively coupled to other components via a system bus 202. A cache 206, a Read Only Memory (ROM) 208, a Random Access Memory (RAM) 210, an input/output (I/O) adapter 220, a sound adapter 230, a network adapter 240, a user interface adapter 250, and a display adapter 260, are operatively coupled to the system bus 202.

A first storage device 222 and a second storage device 224 are operatively coupled to system bus 202 by the I/O adapter 220. The storage devices 222 and 224 can be any of a disk storage device (e.g., a magnetic or optical disk storage device), a solid state magnetic device, and so forth. The storage devices 222 and 224 can be the same type of storage device or different types of storage devices.

A speaker 232 is operative coupled to system bus 202 by the sound adapter 230.

A transceiver 242 is operatively coupled to system bus 202 by network adapter 240.

A first user input device 252, a second user input device 254, and a third user input device 256 are operatively coupled to system bus 202 by user interface adapter 250. The user input devices 252, 254, and 256 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 252, 254, and 256 can be the same type of user input device or different types of user input devices. The user input devices 252, 254, and 256 are used to input and output information to and from system 200.

A display device 262 is operatively coupled to system bus 202 by display adapter 260.

Of course, the processing system 200 may also include other elements (not shown), as readily contemplated by one of skill in the art, as well as omit certain elements. For example, various other input devices and/or output devices can be included in processing system 200, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 200 are readily contemplated by one of ordinary skill in the art given the teachings of the present principles provided herein.

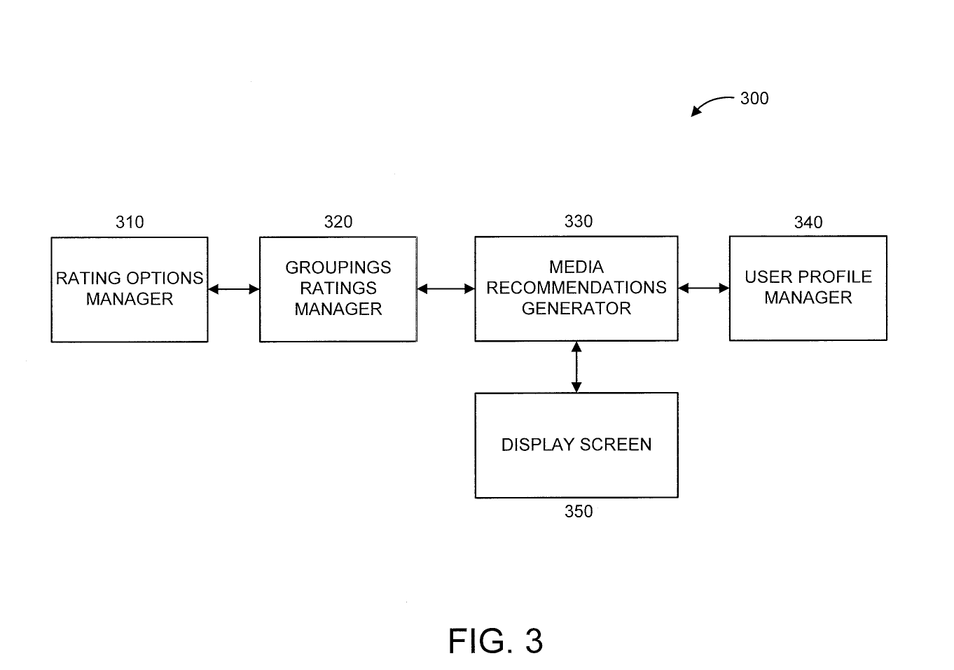

Moreover, it is to be appreciated that system 300 described below with respect to FIG. 3 is a system for implementing respective embodiments of the present principles. Part or all of processing system 200 may be implemented in one or more of the elements of system 300.

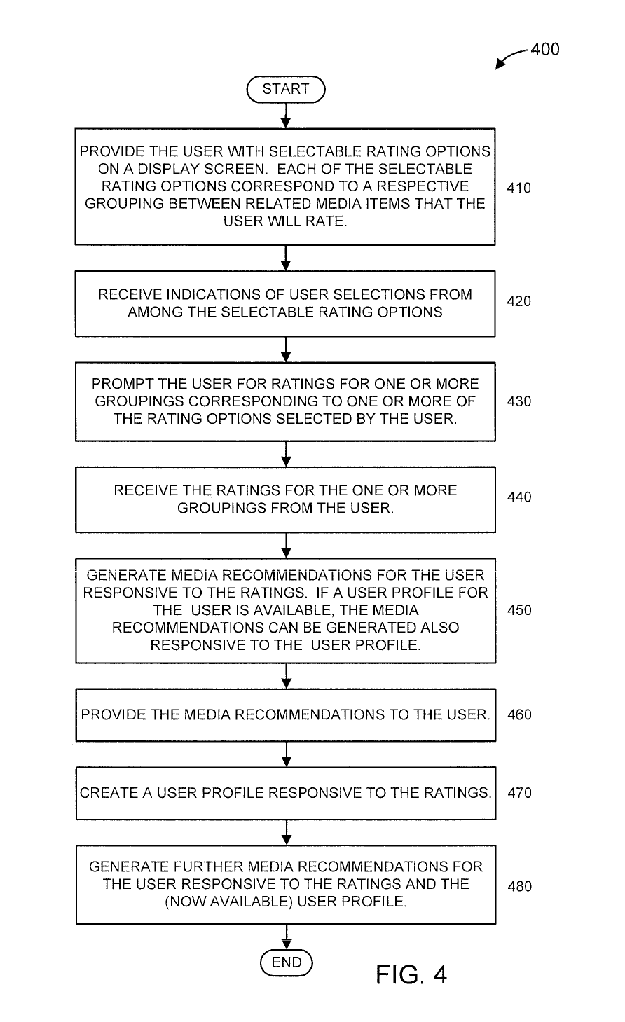

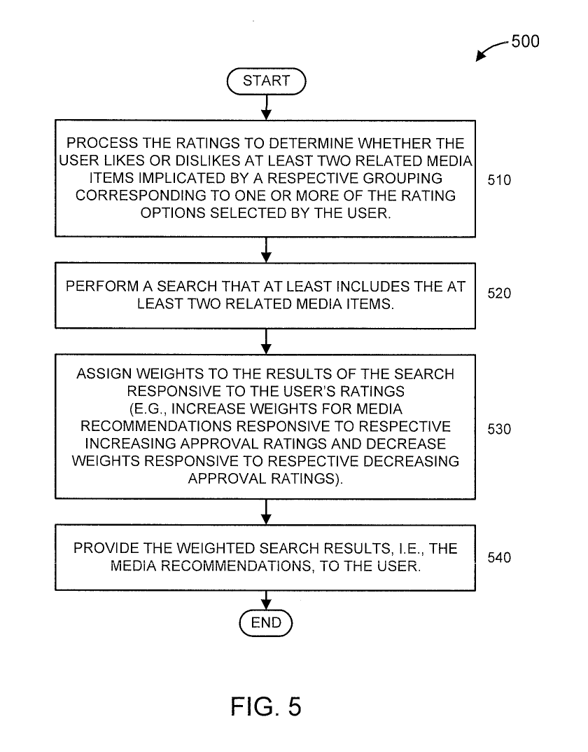

Further, it is to be appreciated that processing system 200 may perform at least part of the method described herein including, for example, at least part of method 400 of FIG. 4 and/or at least part of method 500 of FIG. 5. Similarly, part or all of system 300 may be used to perform at least part of method 400 of FIG. 4 and/or at least part of method 500 of FIG. 5.

FIG. 3 shows an exemplary system 300 for recommending media to a user, in accordance with an embodiment of the present principles. The system 300 includes and/or otherwise involves a ratings options manager 310, a grouping ratings manager 320, media recommendation generator 330, a user profile manager 340, and a display screen 350.

The ratings options manager 310 manages the available rating options that are selectable by a user. Accordingly, the ratings options manager 310 provides the user with selectable rating options on a display screen. Each of the selectable rating options correspond to a respective grouping between related media items that the user will rate. One or more of these rating options can be selected by the user. Accordingly, the ratings options manager 310 receives indications of user selections from among the selectable rating options.

The groupings ratings manager 320 prompts the user for ratings for one or more groupings corresponding to one or more of the rating options selected by the user, and receives the ratings for the one or more groupings from the user.

The media recommendation generator 330 generates media recommendations for the user responsive to the ratings and provides the media recommendations to the user (e.g., displayed on the display screen 350). In an embodiment, the media recommendation generator 330 can weigh the media recommendations responsive to the user's ratings. In this way, groupings that the user prefers more are weighted more and groupings that the user prefers less are weighted less.

The user profile manager 340 generates and/or manages a user profile responsive to the ratings provided by the user. In an embodiment, the user profile, in turn, can also be provided to the media recommendation generator 330 for use in generating the media recommendations.

While the display screen 350 is shown as part of the system 300 in FIG. 3, in other embodiments the system 300 may simply interact with the display screen 350, which can be part of a different system or device (such as a content consumption or content presentation device). Moreover, in an embodiment, the entirety of system 300 is part of a content consumption or content presentation device. Further, in other embodiments, one or more of the elements of system 300 can be distributed for use by more than one content consumption or content presentation device. These and other variations of the elements of FIG. 3 are readily determined by one of ordinary skill in the art, given the teachings of the present principles provided herein, while maintaining the spirit of the present principles.

FIG. 4 shows an exemplary method 400 for recommending media to a user, in accordance with an embodiment of the present principles.

At step 410, provide the user with selectable rating options on a display screen. Each of the selectable rating options correspond to a respective grouping between related media items that the user will rate. One or more of these rating options can be selected by the user.

At step 420, receive indications of user selections from among the selectable rating options.

At step 430, prompt the user for ratings for one or more groupings corresponding to one or more of the rating options selected by the user.

At step 440, receive the ratings for the one or more groupings from the user.

At step 450, generate media recommendations for the user responsive to the ratings. In an embodiment, step 450 can involve generating the media recommendations for the user responsive to the ratings and a user profile if the user profile available. Such a user profile is presumed to be created and maintained based on ratings provided by the user.

At step 460, provide (e.g., display on a display screen) the media recommendations to the user.

At step 470, create a user profile responsive to the ratings.

At step 480, generate further media recommendations for the user responsive to the ratings and the (now available) user profile.

FIG. 5 shows further shows step 450 of method 400 of FIG. 4, in accordance with an embodiment of the present principles.

At step 510, process the ratings to determine whether the user likes or dislikes at least two related media items implicated by a respective grouping corresponding to one or more of the rating options selected by the user. The at least two related media items can be, for example, but are not limited to, two or more particular actors, two or more particular directors, a particular actor(s) and a particular director(s), a media genre and a person (actor/director, etc.), a media genre and a country, and so forth. It is to be appreciated that the ratings can binary (like, dislike) or non-binary (e.g., using a pre-determined range, e.g., from 1 to 10, 1 to 100, A to F, and so forth). In the case of non-binary ratings, the “level” of like or dislike can be taken into account in step 530 hereinafter.

At step 520, perform a search that at least includes the at least two related media items.

At step 530, assign weights to the results of the search performed at step 520 responsive to the user's ratings. For example, the media recommendations are weighted such that respective weights for the media recommendations increase responsive to respective increasing approval ratings and such that the respective weights for the media recommendations decrease with respective decreasing approval ratings.

At step 540, provide (e.g., display) the weighted search results, that is, the media recommendations, to the user.

The present principles will now be further described with respect to exemplary rating scenarios to which the present principles can be applied.

Instead of rating movies by themselves, or even directors or actors by themselves, the present principles allow a user to rate the performance of actors together (such as how would you rate Robert Redford and Paul Newman together) instead of rating Robert Redford or Paul Newman by themselves. These types of ratings can then be used to generate a list of content/recommendations.

The following are exemplary rating scenarios to which the present principles can be applied. Each of the rating scenarios corresponds to a respective exemplary grouping to which the present principles can be applied. It is to be appreciated that such rating scenarios are provided for illustrative purposes and, given the teachings of the present principles provided herein, one of ordinary skill in the related art will contemplate these and various other rating scenarios to which the present principles can be applied, while maintaining the spirit of the present principles.

A first exemplary rating scenario can involve how actors act together (actor & actor). This can be done for a specific movie. For example, the user can be asked how they liked Redford and Newman in The Sting. As another example, the user can be asked how they liked Redford and Newman in Butch Cassidy and the Sundance Kid.

A second exemplary rating scenario can involve how an actor works with a director (actor & director).

A third exemplary rating scenario can involve how an actor works in a specific genre. For example, the user can be asked how they like actor X in science fiction movies. As another example, the user can be asked how they liked actor Y in dramas.

A fourth exemplary rating scenario can involve how an actor works in a movie relating to a particular country. For example, the user can be asked how they liked actor X in an American Movie. As another example, the user can be asked how they liked actor Y in a British movie.

These types of ratings can be used for then generating programming suggestions for use by, e.g., a digital content providing service (including, but not limited to, e.g., M-GO™) and so forth. Of course, the present principles can be used with respect to other digital content service providers/systems while maintaining the spirit of the present principles.

A description will now be given of some of the many attendant advantages/features of the present invention, some of which have been mentioned above. For example, one advantage/feature is a method that includes providing on a display screen a plurality of rating options for a user to select from among. Each of the plurality of rating options corresponds to a respective grouping between at least two related media items to be rated by the user. The method further includes receiving a rating for the respective grouping between the at least two related media items corresponding to a user selected one of the plurality of rating options. The method also includes generating media recommendations for the user responsive to the rating. The method further includes providing the media recommendations to the user on the display screen.

Another advantage/feature is the method as described above, wherein the grouping is between at least two people with respect to a particular media content with which the at least two people are associated.

Yet another advantage/feature is the method wherein the grouping is between at least two people with respect to a particular media content with which the at least two people are associated as described above, and wherein the at least two people comprise at least one of an actor and a director.

Still another advantage/feature is the method as described above, wherein the grouping is between a specific media genre and a person or a country.

Moreover, another advantage/feature is the method as described above, wherein the grouping is between a person and media associated with a particular country.

Further, another advantage/feature is the method as described above, further including generating a user profile responsive to the rating, and using the user profile to generate further media recommendations.

Also, another advantage/feature is the method as described above, further including assigning weights to the media recommendations such that the weights for the media recommendations increase responsive to respective increasing approval ratings and such that the weights for the media recommendations decrease with respective decreasing approval ratings.

These and other features and advantages of the present principles may be readily ascertained by one of ordinary skill in the pertinent art based on the teachings herein. It is to be understood that the teachings of the present principles may be implemented in various forms of hardware, software, firmware, special purpose processors, or combinations thereof.

Most preferably, the teachings of the present principles are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Although the illustrative embodiments have been described herein with reference to the accompanying drawings, it is to be understood that the present principles is not limited to those precise embodiments, and that various changes and modifications may be effected therein by one of ordinary skill in the pertinent art without departing from the scope or spirit of the present principles. All such changes and modifications are intended to be included within the scope of the present principles as set forth in the appended claims.

1. A method comprising:
providing on a display screen a plurality of rating options for a user to select from among, each of the plurality of rating options corresponding to a respective grouping between at least two related media items to be rated by the user;
receiving a rating for the respective grouping between the at least two related media items corresponding to a user selected one of the plurality of rating options;
generating media recommendations for the user responsive to the rating; and
providing the media recommendations to the user on the display screen.

2. The method of claim 1, wherein the grouping is between at least two people with respect to a particular media content with which the at least two people are associated.

3. The method of claim 2, wherein the at least two people comprise at least one of an actor and a director.

4. The method of claim 1, wherein the grouping is between a specific media genre and a person or a country.

5. The method of claim 1, wherein the grouping is between a person and media associated with a particular country.

6. The method of claim 1, further comprising:
generating a user profile responsive to the rating; and
using the user profile to generate further media recommendations.

7. The method of claim 1, further comprising assigning weights to the media recommendations such that the weights for the media recommendations increase responsive to respective increasing approval ratings and such that the weights for the media recommendations decrease with respective decreasing approval ratings.

8. A system comprising:
a ratings options manager for providing on a display screen a plurality of rating options for a user to select from among, each of the plurality of rating options corresponding to a respective grouping between at least two related media items to be rated by the user, and for receiving a rating for the respective grouping between the at least two related media items corresponding to a user selected one of the plurality of rating options; and
a media recommendation generator for generating media recommendations for the user responsive to the rating.

9. The system of claim 8, wherein the grouping is between at least two people with respect to a particular media content with which the at least two people are associated.

10. The system of claim 9, wherein the at least two people comprise at least one of an actor and a director.

11. The system of claim 8, wherein the grouping is between a specific media genre and a person or a country.

12. The system of claim 8, wherein the grouping is between a person and media associated with a particular country.

13. The system of claim 8, further comprising a user profile manager (340) for generating a user profile responsive to the rating.

14. The system of claim 8, wherein the media recommendation generator assigns weights to the media recommendations such that the weights for the media recommendations increase responsive to respective increasing approval ratings and such that the weights for the media recommendations decrease with respective decreasing approval ratings.

15. A non-transitory computer readable storage medium having computer executable code stored thereon for performing a method, the method comprising:
providing on a display screen a plurality of rating options for a user to select from among, each of the plurality of rating options corresponding to a respective grouping between at least two related media items to be rated by the user;
receiving a rating for the respective grouping between the at least two related media items corresponding to a user selected one of the plurality of rating options;
generating media recommendations for the user responsive to the rating; and
providing the media recommendations to the user on the display screen.
